(19) United States
(12) Patent Application Publication
(10) Pub. No.: US 2026/0228413 A1
(43) Pub. Date: Aug. 6, 2026

(54) WEBPAGE LAYOUT OPTIMIZATION

(71) Applicant: Walmart Apollo, LLC, Bentonville, AR (US)

(72) Inventors: Shashank Kedia, Sunnyvale, CA (US); Jongseok Han, Sunnyvale, CA (US); Abdus Saboor Khan, Santa Clara, CA (US); Afroza Ali, Los Altos, CA (US); Abhimanyu Mitra, Cupertino, CA (US); Kannan Achan, Saratoga, CA (US)

(21) Appl. No.: 19/042,228

(22) Filed: Jan. 31, 2025

(51) Int. Cl. G06F 40/106; G06Q 30/0282

(52) U.S. Cl. CPC G06F 40/106; G06Q 30/0282

(57) ABSTRACT

Examples may be related to webpage layout optimization. An example may involve: obtaining a request regarding a webpage; determining feature data associated with the webpage based on the request; determining at least one metric associated with the webpage; generating, based on the feature data and the at least one metric, a plurality of reward scores for a plurality of page elements respectively, wherein each reward score indicates a reward of a respective page element with respect to the at least one metric; determining a layout of the webpage based on the plurality of reward scores and the plurality of page elements; and creating the webpage according to the determined layout.

### BACKGROUND

A webpage can include various elements organized thereon. Due to a limited space on a webpage, different page elements may be selected to be displayed on the webpage based on the type and functionality of the webpage. For a given type of webpages, e.g. an item page showing details of an item, user behaviors could be very different, e.g. depending on the item shown on the item page.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for webpage layout optimization, in accordance with some embodiments;

FIG. 2 is a block diagram of a webpage layout optimization device, in accordance with some embodiments;

FIG. 3 is a block diagram illustrating various portions of a system for webpage layout optimization, in accordance with some embodiments;

FIG. 4 illustrates an example architecture of a system for webpage layout optimization, in accordance with some embodiments;

FIG. 5 illustrates an example webpage with an optimized layout, in accordance with some embodiments;

FIG. 6 illustrates an example user interface showing an example webpage generated based on different layouts at different time, in accordance with some embodiments;

FIG. 7 shows a flowchart illustrating an example method for webpage layout optimization, in accordance with some embodiments;

FIG. 8 shows a flowchart illustrating an example method for determining feature data, in accordance with some embodiments;

FIG. 9 shows a flowchart illustrating an example method for generating a plurality of reward scores, in accordance with some embodiments;

FIG. 10 shows a flowchart illustrating an example method for generating a plurality of weights, in accordance with some embodiments;

FIG. 11 shows a flowchart illustrating an example method for determining a degree of importance of a page element, in accordance with some embodiments;

FIG. 12 shows a flowchart illustrating an example method for determining a layout of a webpage, in accordance with some embodiments;

FIG. 13 shows a flowchart illustrating an example method for updating a layout of a webpage, in accordance with some embodiments;

FIG. 14 depicts an example system with a machine-readable medium that includes instructions for webpage layout optimization, in accordance with some embodiments.

### DETAILED DESCRIPTION

In some embodiments, systems and methods are described herein for generating a webpage with an optimized layout. A layout of a webpage can be adaptive to each user's needs based on user behaviors, and optimized according to one or more metrics.

For example, a disclosed system can present an item page with different layouts (e.g. different page elements and/or different arrangements of page elements) to different users, based on each user's historical behaviors and context information. This would fit the users' needs much better compared to showing the item page with a same layout to all users regardless of their different behaviors and context information.

In some examples, an item page for a product may include one or more page elements of: product title, product images, product description, similar item recommendation, complementary item recommendation, product reviews, display advertisements, etc. In some embodiments, a disclosed system can update and show the item page to a user, by arranging various elements according to different layouts of the item page based on the user's historical or recent behaviors. For example, if a user lands on the item page for the first time before exploring any other product, the item page may be displayed with a first layout that focuses more on information of the product than recommendation elements. In another example, if a user lands on the item page for the second or third time after exploring multiple similar products, the item page may be displayed with a second layout that focuses more on a comparison of the product with other products.

In some embodiments, to create or update a webpage, a disclosed system may select and rank page elements that are optimized according to at least one metric. For example, optimization metrics for page elements on an item page may include: a buy box add-to-cart (ATC) rate indicating a rate of adding an item to cart through a buy box section on the item page of the item, a module direct ATC rate indicating a rate of adding an item to cart when the item is displayed in a recommendation module or carousal on the item page, a module attributable ATC rate indicating a rate of adding an item to cart on a webpage that is shown after a user selecting the item in a recommendation module or carousal on the item page, a module click through rate for a module on the item page, a bounce rate indicating a rate of not engaging with the item after a user comes from an external traffic, a sponsored advertisement revenue for a sponsored advertisement element, a display advertisement revenue for a display advertisement element, a marketplace engagement of sellers, a complementary item ATC rate indicating a rate of adding an item to cart when the item is recommended as a complementary item on the item page, a recommendation diversity indicating a diversity of recommended items on the item page.

In some embodiments, a disclosed system can identify statistically important contexts to webpage performance using a context evaluation framework. In some examples, the system may assess the impact of each page element on each of a plurality of metrics, based on the identified contexts. When some of the plurality of metrics are competing with each other, the system can balance between the competing metrics to optimize the layout of a webpage.

In some examples, the system may generate weights based on the determined context and element impact data, and generate a reward score for each page element by combining metric scores of the element regarding different metrics with the generated weights. The system may then determine a webpage layout based on the elements and their reward scores, and create or update the webpage according to the determined layout.

In some embodiments, the system provides a dynamic webpage layout optimization which is robust to any change in user behavior. Upon receiving an update of user interaction data, e.g. an updated amount of use of a page element, the system can generate an updated reward score for at least one page element and determine an updated layout of the webpage based on the updated reward score. The webpage may be updated automatically and dynamically by moving the at least one page element to a new position on the webpage according to the updated layout.

In various embodiments, a system including a processor and a non-transitory memory storing instructions is disclosed. The instructions, when executed, cause the processor to: obtain a request regarding a webpage; determine feature data associated with the webpage based on the request; determine at least one metric associated with the webpage; generate, based on the feature data and the at least one metric, a plurality of reward scores for a plurality of page elements respectively, wherein each reward score indicates a reward of a respective page element with respect to the at least one metric; determine a layout of the webpage based on the plurality of reward scores and the plurality of page elements; and create the webpage according to the determined layout.

In various embodiments, a computer-implemented method is disclosed. The computer-implemented method includes: obtaining a request regarding a webpage; determining feature data associated with the webpage based on the request; determining at least one metric associated with the webpage; generating, based on the feature data and the at least one metric, a plurality of reward scores for a plurality of page elements respectively, wherein each reward score indicates a reward of a respective page element with respect to the at least one metric; determining a layout of the webpage based on the plurality of reward scores and the plurality of page elements; and creating the webpage according to the determined layout.

In various embodiments, a non-transitory computer readable medium having instructions stored thereon is disclosed. The instructions, when executed by at least one processor, cause at least one device to perform operations including: obtaining a request regarding a webpage; determining feature data associated with the webpage based on the request; determining at least one metric associated with the webpage; generating, based on the feature data and the at least one metric, a plurality of reward scores for a plurality of page elements respectively, wherein each reward score indicates a reward of a respective page element with respect to the at least one metric; determining a layout of the webpage based on the plurality of reward scores and the plurality of page elements; and creating the webpage according to the determined layout.

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

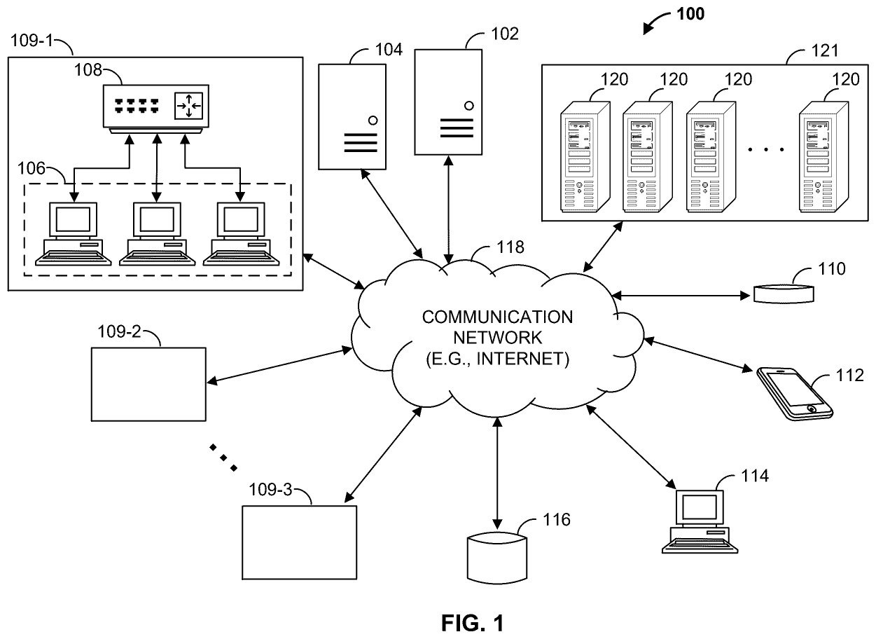

Turning to the drawings, FIG. 1 is a network environment 100 configured for webpage layout optimization, in accordance with some embodiments. The network environment 100 includes a plurality of devices or systems that can communicate over one or more network channels, illustrated as a network cloud 118. For example, in various embodiments, the network environment 100 can include, but not limited to, a webpage layout optimization device 102, a server 104 (e.g., a web server or an application server), a cloud-based engine 121 including one or more processing devices 120, workstation(s) 106, a database 116, and one or more user computing devices 110, 112, 114 operatively coupled over the network 118. The webpage layout optimization device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the webpage layout optimization device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing Units (TPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the webpage layout optimization device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the webpage layout optimization device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the webpage layout optimization device 102 over the communication network 118. The workstation(s) 106 may send data to, and receive data from, the webpage layout optimization device 102. For example, the workstation(s) 106 may transmit data identifying transactions, inventory, assortment, supply chain data and/or waste data at the one or more fulfillment nodes 109 to the webpage layout optimization device 102. The workstation(s) 106 may also transmit other data related to the one or more fulfillment nodes 109 to the webpage layout optimization device 102.

Although FIG. 1 illustrates three user computing devices 110, 112, 114, the network environment 100 can include any number of user computing devices 110, 112, 114. Similarly, the network environment 100 can include any number of the webpage layout optimization devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the webpage layout optimization device 102 over the communication network 118. The website may also enable the customer to add one or more of the items to an online shopping cart, and enable the customer to perform a “checkout” of the shopping cart to purchase the items. In some examples, the server 104 transmits purchase data identifying items the customer has purchased from the website to the webpage layout optimization device 102.

In some examples, the server 104 transmits a webpage request to the webpage layout optimization device 102. The webpage request may be sent regarding a generation or update of a webpage associated with an item. For example, a user submits a request for an item page on a website hosted by the server 104, e.g. by clicking on the item in a search result list or recommendation list to view its product description details. The server 104 may generate and send the webpage request to the webpage layout optimization device 102, e.g. together with user session data of the user. The webpage layout optimization device 102 may determine feature data associated with the webpage and determine at least one metric associated with the webpage. Based on the feature data and the at least one metric, the webpage layout optimization device 102 can generate a plurality of reward scores for a plurality of page elements respectively, and determine a layout of the webpage based on the plurality of reward scores and the plurality of page elements. The webpage layout optimization device 102 can then create and transmit the webpage data to the server 104 for presenting the webpage to the user according to the determined layout.

In some embodiments, the webpage layout optimization device 102 is further operable to communicate with the database 116 over the communication network 118. For example, the webpage layout optimization device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the webpage layout optimization device 102, in some examples, the database 116 can be a local storage device, such as a hard drive, a non-volatile memory, or a USB stick. For example, the webpage layout optimization device 102 may store online purchase data received from the server 104 in the database 116. The webpage layout optimization device 102 may receive in-store purchase data and node related data from different nodes 109 and store them in the database 116. The webpage layout optimization device 102 may also receive from the server 104 user session data identifying events associated with browsing sessions, and may store the user session data in the database 116. The webpage layout optimization device 102 may also compute recommendation data in response to a webpage request received from the server 104 (or the nodes 109), and may store the recommendation data in the database 116.

In some examples, the webpage layout optimization device 102 generates and/or updates different models (e.g., machine learning models, deep learning models, statistical models, algorithms, natural language models, etc.) for webpage layout optimization. The webpage layout optimization device 102 may generate training data for the models based on data including but not limited to: item features, page element data, user historical interaction data, historical sale data, historical layout data, metric data, and historical user feedback data. The webpage layout optimization device 102 trains the models based on their corresponding training data, and stores the models in a database, such as in the database 116 (e.g., a cloud storage). The models, when executed by the webpage layout optimization device 102, enable the webpage layout optimization device 102 to create or update webpage layouts.

In some examples, the webpage layout optimization device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the webpage layout optimization device 102 may create or update webpage layouts.

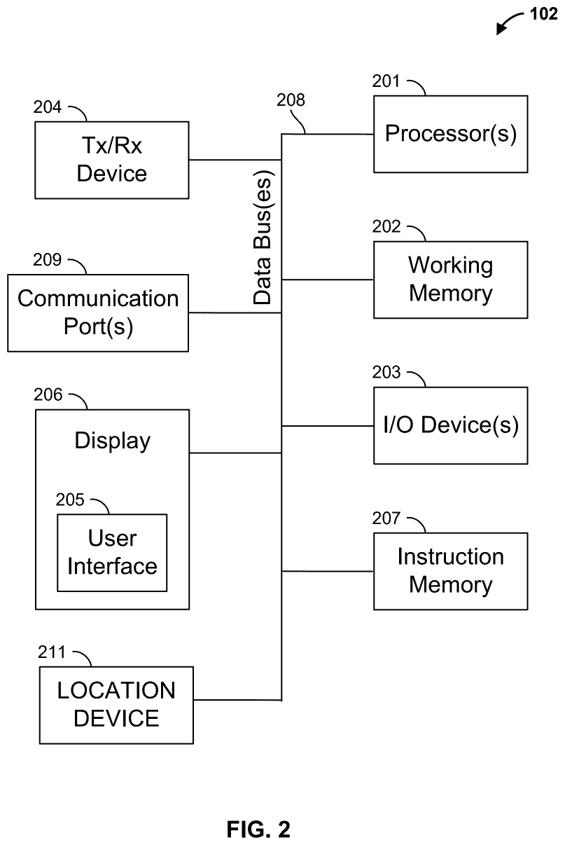

FIG. 2 illustrates a block diagram of a webpage layout optimization device, e.g. the webpage layout optimization device 102 of FIG. 1, in accordance with some embodiments. In some embodiments, each of the webpage layout optimization device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the webpage layout optimization device 102 can be combined, omitted, and/or replicated. In addition, it will be appreciated that additional elements other than those illustrated in FIG. 2 can be added to the webpage layout optimization device 102.

As shown in FIG. 2, the webpage layout optimization device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 enable communication among the various components. The data buses 208 can include wired, or wireless, communication channels.

The one or more processors 201 can include any processing circuitry operable to control operations of the webpage layout optimization device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the webpage layout optimization device 102 can include a single memory unit to operate as both instruction memory and working memory. Further, although embodiments are discussed herein including non-volatile memory, it will be appreciated that the webpage layout optimization device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that enables data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 enable communication with a network, such as the communication network 118 of FIG. 1. For example, if the communication network 118 of FIG. 1 is a cellular network, the transceiver 204 enables communications with the cellular network. In some embodiments, the transceiver 204 is selected based on the type of the communication network 118 the webpage layout optimization device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the webpage layout optimization device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 enables the programming of executable instructions in the instruction memory 207. In some embodiments, the communication port(s) 209 enables the transfer (e.g., uploading or downloading) of data, such as machine learning model training data.

In some embodiments, the communication port(s) 209 may couple the webpage layout optimization device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the webpage layout optimization device 102 and/or the server 104. For example, the user interface 205 can be a user interface for an application of a network environment operator that enables a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the webpage layout optimization device 102 may determine a local geographical area (e.g., town, city, state, etc.) of its position.

In some embodiments, the webpage layout optimization device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

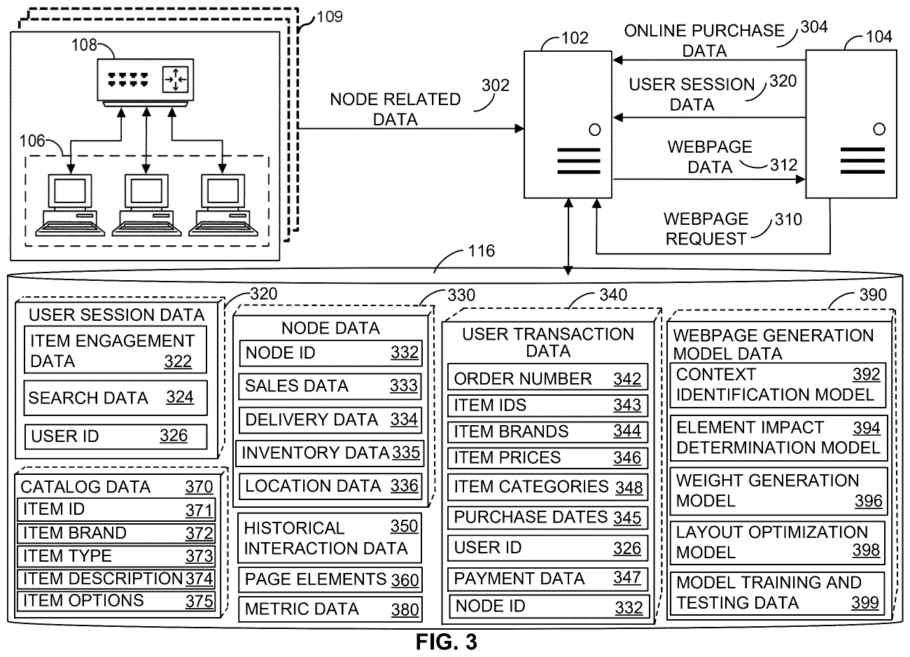

FIG. 3 is a block diagram illustrating various portions of a system for webpage layout optimization, e.g. the system shown in the network environment 100 of FIG. 1, in accordance with some embodiments. As indicated in FIG. 3, the webpage layout optimization device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for recommending and optimizing inventory target levels for items.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items viewed by the user, items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The webpage layout optimization device 102 may also receive online purchase data 304 from the server 104, which identifies and characterizes one or more online purchases, such as purchases made by the user and other users via a retailer's website hosted by the server 104. The webpage layout optimization device 102 may also receive node related data 302 from the fulfillment nodes 109, which identifies and characterizes one or more in-store purchases, product location data, inventory data, and/or assortment data related to each of the fulfillment nodes 109. In some embodiments, the node related data 302 may also indicate other information about the fulfillment nodes 109. In some embodiments, the fulfillment nodes 109 and the server 104 are associated with each other such that the online purchase data 304, the user session data 320 and the node related data 302 all come from a same server cluster or datacenter.

The webpage layout optimization device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping—from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some embodiments, the webpage layout optimization device 102 may generate node data 330 based on the node related data 302. In some examples, the node data 330 may include, for each node, one or more of: the node ID 332 of the node, sales data 333 indicating data of historical sales for each item in the node, delivery data 334 indicating data of historical deliveries of each item to and from the node, inventory data 335 identifying and charactering an inventory status for each item in the node, and location data 336 identifying a location of the node.

In some examples, the database 116 may also store historical interaction data 350 identifying historical user interactions with webpages of a website hosted by the server 104. In some examples, the database 116 may also store page elements 360 available for creating a webpage, and store metric data 380 identifying various metrics for optimizing a layout of a webpage.

In some examples, the webpage layout optimization device 102 receives a webpage request 310 regarding a creation or update of a webpage associated with an item. The webpage request 310 may be triggered by a user interacting with a website hosted by the server 104. In some examples, the webpage request 310 may be embedded in the user session data 320 without being separately sent or identified. In response, the webpage layout optimization device 102 may determine feature data associated with the webpage based on the request, and determine at least one metric associated with the webpage. In some embodiments, the webpage layout optimization device 102 can generate a plurality of reward scores for a plurality of page elements respectively based on the feature data and the at least one metric. Each reward score may indicate a reward of a respective page element with respect to the at least one metric. The webpage layout optimization device 102 may determine a layout of the webpage based on the plurality of reward scores and the plurality of page elements. The webpage layout optimization device 102 may then create and transmit webpage data 312 to the server 104 for presenting the webpage according to the determined layout.

The database 116 may also store webpage generation model data 390 identifying and characterizing one or more models and related data for webpage layout optimization. For example, the webpage generation model data 390 may include: a context identification model 392, an element impact determination model 394, a weight generation model 396, a layout optimization model 398 and model training and testing data 399. In various embodiments, the webpage generation model data 390 includes any number of the context identification models 392, the element impact determination models 394, the weight generation models 396, and the layout optimization models 398.

The context identification model 392 in some examples can be used to identify contexts to generate feature data based on a request, e.g. the webpage request 310, regarding a webpage associated with an item. In some examples, the context identification model 392 may be used to determine historical user interaction data regarding a plurality of page elements associated with the webpage, and determine a plurality of contextual features associated with the webpage. From the plurality of contextual features, the context identification model 392 may be used to select at least one contextual feature that is statistically important to a performance of the webpage based on the historical user interaction data, and filter the historical user interaction data to generate the feature data based on the at least one contextual feature.

The element impact determination model 394 in some examples can be used to determine a degree of importance of each page element with respect to each metric of a plurality of metrics. For example, the element impact determination model 394 may be used to determine at least one interaction feature associated with the page element, and estimate an impact of the at least one interaction feature on the metric based on the feature data generated by the context identification model 392.

The degree of importance of the page element may be determined based on the estimated impact.

The weight generation model 396 in some examples can be used to generate, for each page element, a plurality of weights associated with the plurality of metrics, respectively. For example, the weight generation model 396 may be an explore-exploit model used to generate a weight for each metric based on the at least one contextual feature selected by the context identification model 392. In some examples, the weight generation model 396 may be generated based on a posterior distribution or a neural network. Given each user interaction with the page element within a time period, the weight generation model 396 may be used to update the weight for each metric based on the degree of importance of the page element determined by the element impact determination model 394.

The layout optimization model 398 in some examples can be used to generate a plurality of reward scores for a plurality of page elements respectively, and rank the plurality of page elements based on their respective reward scores to generate an optimized layout for the webpage. In some examples, the reward score for each page element is generated by combining metric scores of the page element regarding different metrics based on the weights generated by the weight generation model 396. Each reward score may indicate a reward of a respective page element regarding the metrics. In some examples, based on the ranking and a threshold, the layout optimization model 398 can be used to select a list of page elements from the plurality of page elements, and determining one or more layout features for each selected page element in the list based on its reward score. The one or more layout features may comprise at least one of: a position, a size, a shape or a color of the selected page element. Then, the webpage is created or updated by arranging the list of page elements on the webpage according to the one or more layout features.

In some embodiments, one or more of the context identification model 392, the element impact determination model 394, the weight generation model 396 and the layout optimization model 398 can be implemented as a machine learning model, a deep learning model, a neural network or a large language model. The model training and testing data 399 may include data utilized for training one or more of the context identification model 392, the element impact determination model 394, the weight generation model 396 and the layout optimization model 398. In some examples, the model training and testing data 399 may be formed based on: item features, page element data, historical or labelled user interaction data, historical or labelled sale data, historical or labelled layout data, metric data, and historical user feedback data, obtained from either real data or synthetic data.

In some embodiments, the webpage layout optimization device 102 may assign one or more of the above described operations to a different processing unit or virtual machine hosted by one or more processing devices 120. Further, the webpage layout optimization device 102 may obtain the outputs of these assigned operations from the processing units, and generate the webpage data 312 based on the outputs.

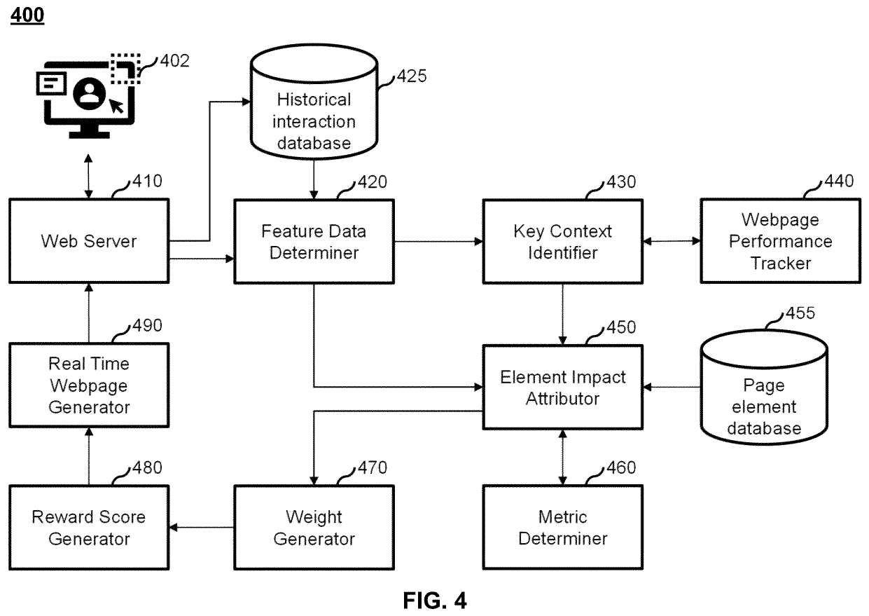

FIG. 4 illustrates an example architecture of a system 400 for webpage layout optimization, in accordance with some embodiments. In some embodiments, the system 400 can be implemented by one or more computing devices, such as the webpage layout optimization device 102, the server 104 and/or the cloud-based engine 121 of FIG. 1.

As shown in FIG. 4, the system 400 in this example includes a web server 410, a feature data determiner 420, a key context identifier 430, a webpage performance tracker 440, an element impact attributor 450, a metric determiner 460, a weight generator 470, a reward score generator 480 and a real time webpage generator 490. In some examples, the web server 410 may be implemented as the server 104 in FIG. 1 and FIG. 3; and the feature data determiner 420, the key context identifier 430, the webpage performance tracker 440, the element impact attributor 450, the metric determiner 460, the weight generator 470, the reward score generator 480 and the real time webpage generator 490 may be implemented as the webpage layout optimization device 102 in FIG. 1 and FIG. 3.

In some embodiments, the web server 410 may be configured to receive user interactions of a user 402 regarding a website or application hosted by the web server 410. The web server 410 may store user interaction data of the user 402 into a historical interaction database 425, which may be part of the database 116 or a standalone database.

In some examples, the user 402 may submit a request to the web server 410 via a user interface. The request may be for a webpage associated with an item, e.g. an item page, a shopping cart page, an order confirmation page, a search page, etc. In some examples, the request may be submitted when the user 402 selects the item in a recommended item list, submits a search query referring to the item, clicks on a display advertisement for the item, etc.

The web server 410 in some examples may forward the request to the feature data determiner 420 for generating or updating the webpage to be presented to the user 402. After obtaining the request, the feature data determiner 420 may determine feature data associated with the webpage based on the request. In some examples, the feature data determiner 420 can determine historical user interaction data regarding the webpage, from the historical interaction database 425. The historical user interaction data determined by the feature data determiner 420 may include data related to interactions of the user 402 and/or other users of the website. Based on the historical user interaction data, the feature data determiner 420 may determine the feature data including at least one of: a plurality of contextual features associated with the webpage, at least one interaction feature associated with the webpage, or one or more layout features for layout optimization of the webpage. The feature data determiner 420 may send the feature data to the key context identifier 430 for key context identification, and to the element impact attributor 450 for element impact analysis.

The key context identifier 430 in some examples may identify key contextual features based on the feature data determined by the feature data determiner 420. In some examples, the key context identifier 430 may communicate with the webpage performance tracker 440 to track a performance of the webpage, e.g. based on a continuous user traffic to the webpage. From the plurality of contextual features in the feature data, the key context identifier 430 can select at least one key contextual feature that is statistically important to the performance of the webpage based on the historical user interaction data. In some examples, the key context identifier 430 may filter the historical user interaction data to generate filtered feature data based on the at least one key contextual feature. The key context identifier 430 may then send the filtered feature data including key contextual feature information to the element impact attributor 450.

In some embodiments, example key contextual features may include: device-wise context identifying a type of device (e.g. based on an operation function running on the device) used for viewing the webpage, category-wise context identifying a product category of the item, internal-external traffic identifying whether the user comes from an internal or external traffic to the webpage, and popularity identifying what items that are visited most often.

The element impact attributor 450 in some examples may obtain the feature data determined by the feature data determiner 420, and obtain the filtered data including key contextual features from the key context identifier 430. In addition, the element impact attributor 450 may also obtain a plurality of page elements associated with the webpage from a page element database 455, which may be part of the database 116 or a standalone database. Further, the element impact attributor 450 may communicate with the metric determiner 460 to determine at least one metric associated with the webpage.

In some examples, a plurality of metrics are determined to be associated with the webpage, e.g. based on a business requirement or a predetermined rule. The element impact attributor 450 can determine a degree of importance of each page element with respect to each metric. For example, the element impact attributor 450 may first determine at least one interaction feature associated with each page element, and then estimate an impact of the at least one interaction feature on each metric based on the feature data. Based on the estimated impact, the element impact attributor 450 can determine the degree of importance of the page element.

In some embodiments, the impacts of heterogenous page elements on a given metric cannot be directly measured. For example, an impact of a comparison chart (e.g. a comparison of similar items) on a webpage may be on an action performed at places (e.g. an add-to-cart button) on the webpage other than the comparison chart itself. As such, an impact of a page element's feature on a metric can be attributed by the element impact attributor 450 to establish an importance of the page element to the metric. For example, given a metric, an impact of the dwell time (e.g. average dwell time of all users) on review element can be attributed to an importance of the review element, an impact of a presence or interaction with a comparison chart can be attributed to an importance of the comparison chart, an impact of a presence of complete-the-look element can be attributed to an importance of the complete-the-look element, and an impact of recently viewed item quality (e.g. how similar a recently viewed item is to the current item be viewed) can be attributed to an importance of the recently-viewed-items element.

The element impact attributor 450 may send the importance data of different page elements to the weight generator 470 for weight generation. In some embodiments, the element impact attributor 450 may also forward the feature data and metric data to the weight generator 470.

The weight generator 470 in some examples may generate a plurality of weights for each page element based on the importance data of different page elements received from the element impact attributor 450. For example, the weight generator 470 can determine or obtain a degree of importance of each page element with respect to each metric based on the importance data generated by the element impact attributor 450, and generate a weight for each metric using an explore-exploit model, e.g. the weight generation model 396, based on the at least one key contextual feature identified by the key context identifier 430. In some embodiments, the explore-exploit model may be generated based on a posterior distribution or a neural network. In some embodiments, the weight generator 470 can update the weight for each metric based on the degree of importance of the page element, given each user interaction with the page element within a time period.

In some embodiments, the explore-exploit model may be built based on a beta prior distribution with parameters α=(α₁, α₂, . . . , α_{K}) and β=(β₁, β₂, . . . , β_{K}), where a probability of user feedbacks with item i can be denoted

$$by P ( {θ}_{i} ) = \frac{Γ ( {α}_{i} + {β}_{i} )}{Γ ( {α}_{i} ) Γ ( {β}_{i} )} {{θ}_{i}^{{α}_{i} - 1} ( 1 - {θ}_{i} )}^{{β}_{i} - 1} .$$

As users interact with the item, the posterior distribution may be updated by Bayes' Rule. The posterior distribution of each carousel module may also be a beta-binomial distribution with parameters:

$$( {α}_{i} , {β}_{i} ) ← \{ \begin{matrix}( {α}_{i} + U , {β}_{i} ) , positive interaction \\ ( {α}_{i} , {β}_{i} + U ) , view but no positive interaction \\ ( {α}_{i} , {β}_{i} ) , no interaction\end{matrix}$$

where U may be an update value depending on the impact or importance determined by the element impact attributor 450 for each page element regarding each metric. Given the parameters of the beta-distribution at any time, the user-item prior may be obtained by: sample \hat{θ}ᵢ~P(θᵢ). In some embodiments, the weight generator 470 may use Thompson sampling to select the item with highest \hat{θ}ᵢ and return the best item i that satisfies i=argmaxᵢ \hat{θ}ᵢ. The sampled values may be used by the weight generator 470 to generate the weights for multiple objective optimization.

In some embodiments, the explore-exploit model may consider key contextual features based on hard identification, where K number of models can run independently under K different contexts. For example, the system 400 may use a context-agnostic model: Score=ƒ(X|α, β), where X is the target arm (representing different webpage layouts) and α, β ∈ [symbol] are beta parameters. Under different contexts, ƒ(·|α, β) may be defined independently such as ƒ_{c1}(X|α_{c1}, β_{c1})≠ƒ_{c2}(X|α_{c2}, β_{c2})≠ . . . ≠ƒ_{ck}(X|α_{ck}, β_{ck}), for same X but different contexts c1, c2, . . . , cK. For hard context identification, the system 400 tends to identify contexts whose importances are big enough, because irrelevant context would interrupt model convergence without any accuracy gain.

In some embodiments, the explore-exploit model may consider key contextual features based on soft identification (e.g. based on a neural network), where the model consumes contextual feature as an input and reflects it in prediction. For example, the system 400 may use a context-aware model: Score=ƒ(X, C|W), where X is the target arms (representing different webpage layouts) and C, W ∈ R^{d} are d-dimensional features. Across all contexts, ƒ(·|W) is shared and contextual signal is captured via C, and may be defined as ƒ(X, C₁|W)≠ƒ(X, C₂|W)≠ . . . ≠ƒ(X, C_{K}|W), for same X, W but different contextual features C₁, C₂, . . . , C_{K}. For soft context identification, the model reflects contextual signal via C and W while it learns the relevance of given context. If a context is meaningless, the model would ignore it by assigning zero values on a corresponding weight W.

The weight generator 470 may send the generated weights to the reward score generator 480 for reward score generation. In some embodiments, the weight generator 470 may also forward the feature data and metric data to the reward score generator 480.

The reward score generator 480 in some examples may generate, based on the feature data and the metric data, a plurality of reward scores for the plurality of page elements respectively. Each reward score may indicate a reward of a respective page element with respect to the one or more metrics determined by the metric determiner 460. In some examples, the reward score generator 480 can obtain the plurality of weights associated with a plurality of metrics, respectively, from the weight generator 470 for each page element. For each page element, the reward score generator 480 may generate a plurality of metric scores associated with the plurality of metrics, respectively. Each metric score may indicate a reward of the page element with respect to a corresponding one of the plurality of metrics. The reward score may be generated for the page element based on a combination of the plurality of metric scores with the plurality of weights.

In some embodiments, the plurality of metrics may include competing metrics. The reward score generator 480 may simultaneously optimize the plurality of metrics including the competing metrics, e.g. by finding a set of optimal solutions, called Pareto-optimal solutions, where no one competing metric can be improved without degrading another competing metric. In some examples, the reward score generator 480 can first generate reward scores that can move from a suboptimal point to a point on a pareto-optimal front curve. Then, based on some relative importance information of metrics, the reward score generator 480 can update the reward scores to move from one point to another point on the pareto-optimal front curve. In some embodiments, the reward score generator 480 may direct generate the reward scores to arrive at a point on the pareto-optimal front curve based on the weights, where are generated by the weight generator 470 in consideration of the since the relative importance information of metrics.

The reward score generator 480 can send the plurality of reward scores to the real time webpage generator 490 for webpage generation or update. In some embodiments, the reward score generator 480 may also forward the feature data and other data related to the plurality of page elements to the real time webpage generator 490.

The real time webpage generator 490 in some examples may determine a layout of the webpage based on the plurality of reward scores generated by the reward score generator 480 and the plurality of page elements. The real time webpage generator 490 may create or update the webpage in real time according to the determined layout. In some examples, the layout of the webpage may be determined based on: ranking the plurality of page elements based on their respective reward scores, selecting a list of page elements from the plurality of page elements based on the ranking and a threshold to generate a ranked list, and determining one or more layout features for each selected page element in the ranked list based on its reward score. The one or more layout features may comprise at least one of: a position, a size, a shape or a color of the selected page element. The ranked list of page elements may be arranged on the created or updated webpage according to the one or more layout features. In some examples, a page element ranked higher in the ranked list is placed at an upper position of the webpage compared to another page element ranked lower in the ranked list. In some examples, a page element ranked higher in the ranked list is displayed with a larger size, a larger font, and/or a brighter color on the webpage compared to another page element ranked lower in the ranked list. The real time webpage generator 490 may send the created or updated webpage to the web server 410 to be presented to the user 402 in response to the request.

In some embodiments, the system 400 may receive updated user interaction data regarding the list of page elements on the webpage. For example, the updated user interaction data may include an amount of use of each page element in the list over a predetermined period of time. The system 400 can generate, e.g. by the reward score generator 480, an updated reward score for at least one page element in the list based on the updated user interaction data, and determine, e.g. by the real time webpage generator 490, an updated layout of the webpage based on the updated reward score. As such, the system 400 can update the webpage according to the updated layout, e.g. by automatically moving the at least one page element to a new position on the webpage, changing a size, a shape or a color of the at least one page element on the webpage, adding a new page element to the webpage, or removing an existing page element from the webpage. In some examples, the layout of the webpage may still be the same as before, based on the updated reward score, e.g. when the relative rankings of the page elements are the same as before based on their updated reward score(s).

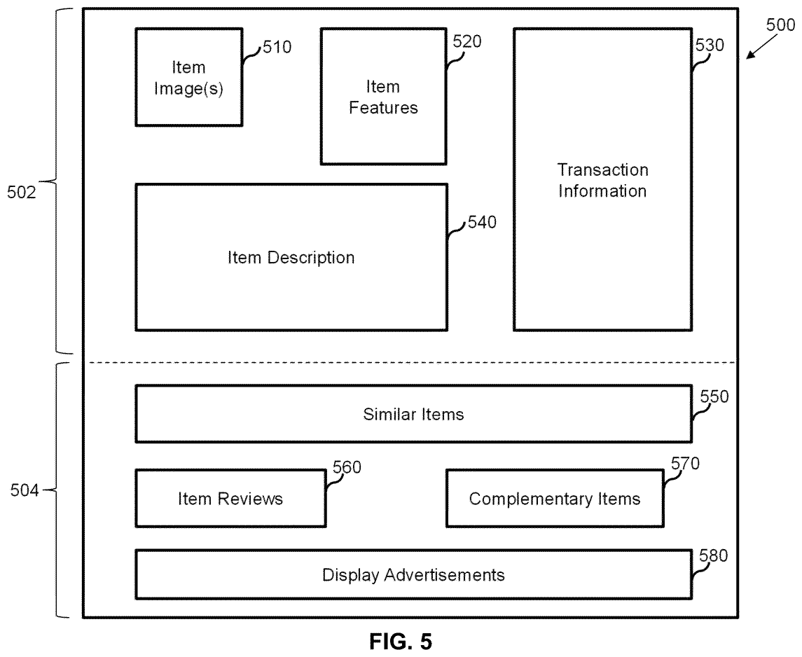

FIG. 5 illustrates an example webpage 500 with an optimized layout, in accordance with some embodiments. In some embodiments, the webpage 500 may be a webpage generated or updated by the system 400 in FIG. 4. In some embodiments, the webpage 500 may be an item page showing detailed descriptions of an item.

As shown in FIG. 5, the webpage 500 includes a basic portion 502 and an extended portion 504. Due to a limited display space of a user interface that can show the webpage 500 at a time, the basic portion 502 may be first displayed on the user interface once a user is directed to the webpage 500. The user can scroll down the webpage 500 on the user interface to view the extended portion 504.

In some examples, the basic portion 502 includes: an item image section 510, an item feature section 520, a transaction information section 530, and an item description section 540. The item image section 510 may show one or more item images of the item. The item feature section 520 may include item features like: item title, brand information, key feature list, etc. The transaction information section 530 may include transaction related information like: price, delivery options, return policy, etc. The item description section 540 may show a detailed description of various features of the item.

In some examples, the extended portion 504 includes: a similar item section 550, an item review section 560, a complementary item section 570 and a display advertisement section 580. The similar item section 550 may show a recommended list of similar items to the item. The item review section 560 may show reviews and/or ratings provided by users regarding the item. The complementary item section 570 may show a recommended list of complementary items that are frequently bought together with the item. The display advertisement section 580 may show one or more display advertisements that are related to the item or the webpage 500.

In some embodiments, the different page elements of the webpage 500 may have different objectives. For examples, the similar item section 550 may help a user to explore similar and different options, the complementary item section 570 may direct the user to move towards next item in the shopping journey, the item description section 540 may provide necessary item details to the user, and the display advertisement section 580 can provide relevant items with promotions.

Although FIG. 5 illustrates one similar item section 550, the webpage 500 can include any number of similar item sections 550 including, e.g. a similar item section based on transactional similarity, another similar item section based on semantic similarity, etc. Similarly, the webpage 500 can include any number of the other page elements, e.g. any number of the complementary item sections 570, the display advertisement sections 580, etc.

In some embodiments, a layout of the webpage 500 can be dynamically updated according to user behaviors as discussed above. In some examples, the page elements in the basic portion 502 are always included in any updated layout of the webpage 500, when the webpage 500 is an item page. In some examples, according to an updated layout, one or more of the page elements in the extended portion 504 may be removed, and one or more additional page elements may be added to the webpage 500. In some examples, according to an updated layout, a page element originally placed in the extended portion 504 may be rearranged to the basic portion 502, and vice versa. In some examples, according to an updated layout, any page element in the webpage 500 can be updated by its size, shape, position, color, or another layout feature. In some examples, according to an updated layout, any page element in the webpage 500 can be removed. In some examples, according to an updated layout, one or more page elements can be added to either the basic portion 502 or the extended portion 504 in the webpage 500.

In some embodiments, the dynamically updated layout enables the webpage 500 to be robust to user changes and to adapt quickly to any updated user behaviors. In some examples, every time a user refreshes an item page, the system performs a new sampling of the beta-binomial distribution to reflect new user interaction information (of the user and other users of the webpage). In addition, the beta-binomial distribution itself may also change as user behaviors (of all users regarding the webpage) change. For example, if users' interests shift from similar items to complementary items, a mean of the beta-binomial distribution would shift accordingly such that the complementary items would have a higher weight than the similar items based on updated sampling. As such, the generated reward score would take into consideration more of the complementary items than the similar items.

In some embodiments, the layout of the webpage 500 can be different for different users visiting the webpage 500. In some embodiments, when a same user visits the webpage 500 for multiple times, the layout of the webpage 500 may be different for each visit. In some embodiments, the layout of the webpage 500 can be different depending on the item identified in the basic portion 502.

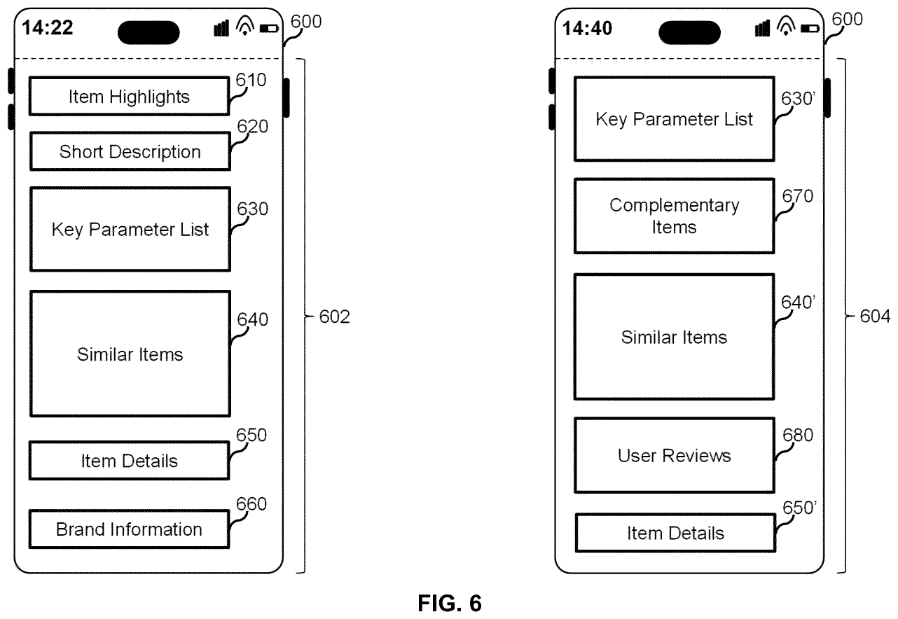

FIG. 6 illustrates an example user interface showing an example webpage 600 generated based on different layouts 602, 604 at different time, in accordance with some embodiments. In some embodiments, the webpage 600 may be a webpage generated or updated by the system 400 in FIG. 4. In some embodiments, the webpage 600 may be an item page showing detailed descriptions of an item. The different layouts 602, 604 are both associated with a same webpage, i.e. the webpage 600, which has a same web address, e.g. a same uniform resource locator (URL) address.

As shown in FIG. 6, the layout 602 of the webpage 600 includes the following page elements ordered from top down: an item highlight section 610, a short description section 620, a key parameter list 630, a similar item section 640, an item detail section 650, and brand information 660. The item highlight section 610 may show some highlighted features of the item. The short description section 620 may include a short description of the item. The key parameter list 630 may show a list of key parameters of the item, e.g. dimension, resolution, refresh rate etc. for a television. The similar item section 640 may show a recommended list of similar items to the item. The item detail section 650 may show a detailed description of various features of the item. The brand information 660 may information about a brand of the item.

As shown in FIG. 6, the layout 604 of the webpage 600 includes the following page elements ordered from top down: a key parameter list 630′, a complementary item section 670, a similar item section 640′, a user review section 680, and an item detail section 650′. The key parameter list 630′ may be the same as the key parameter list 630 in the layout 602, or may include different key parameters or list the key parameters in a different order or manner. The complementary item section 670 may show a recommended list of complementary items that are frequently bought together with the item. The similar item section 640′ may be the same as the similar item section 640 in the layout 602, or may include different items similar to the item or list the similar items in a different order or manner. The user review section 680 may show reviews and/or ratings provided by users regarding the item. The item detail section 650′ may be the same as the item detail section 650 in the layout 602, or may include descriptions of different features of the item or list the different features in a different order or manner.

In some examples, when a user visits the webpage 600 for the first time before exploring any other similar item, the webpage 600 may be displayed with the layout 602 to the user. In some examples, when a user visits the webpage 600 for a time after the first (e.g. the second or third time) after exploring multiple similar items, the webpage 600 may be displayed with the layout 604 to the user. For example, after the user submits a search query “large television,” a search result page including multiple items related to television can be shown to the user. When the user first clicks on one television item (e.g. television A) on the search result page, an item page of television A may be displayed to the user according to the layout 602, which puts more information about television A itself on top of the webpage 600 and puts recommendation and comparison elements (e.g. the similar item section 640) at a lower or bottom portion of the webpage 600. Then after the user views multiple item pages for other televisions, the user may come back to visit the item page of television A again. At this time, the item page of television A may be displayed to the user according to the layout 604, which adds or moves recommendation and comparison elements (e.g. the complementary item section 670) to an upper portion of the webpage 600 compared to the layout 602.

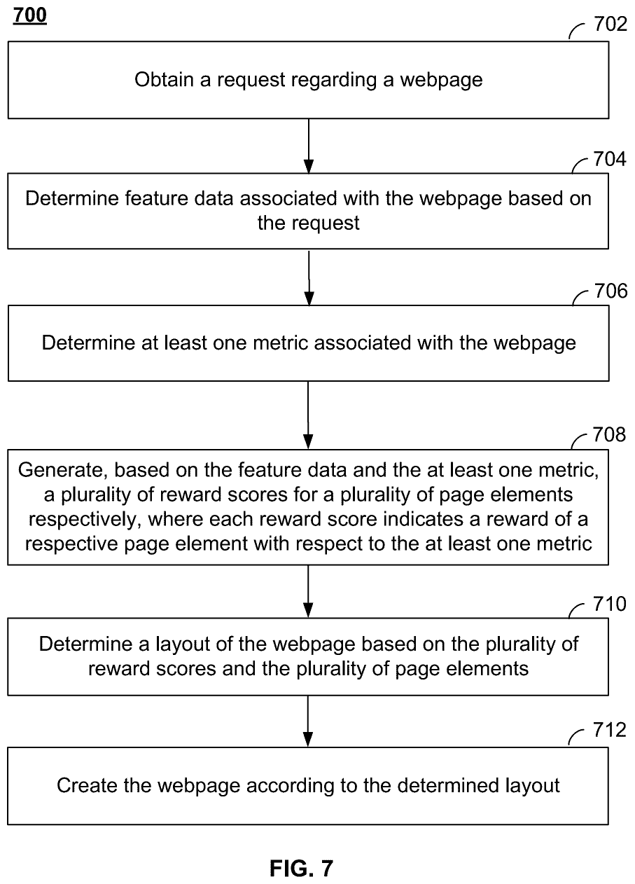

FIG. 7 shows a flowchart illustrating an example method 700 for webpage layout optimization, in accordance with some embodiments. In some embodiments, the method 700 can be carried out by a system including one or more computing devices, such as the webpage layout optimization device 102 and/or the cloud-based engine 121 of FIG. 1. Beginning at operation 702, a request regarding a webpage is obtained. At operation 704, feature data associated with the webpage is determined based on the request. At operation 706, at least one metric associated with the webpage is determined. At operation 708, based on the feature data and the at least one metric, a plurality of reward scores are generated for a plurality of page elements respectively. Each reward score may indicate a reward of a respective page element with respect to the at least one metric. At operation 710, a layout of the webpage is determined based on the plurality of reward scores and the plurality of page elements. The webpage is created (or updated) at operation 712 according to the determined layout.

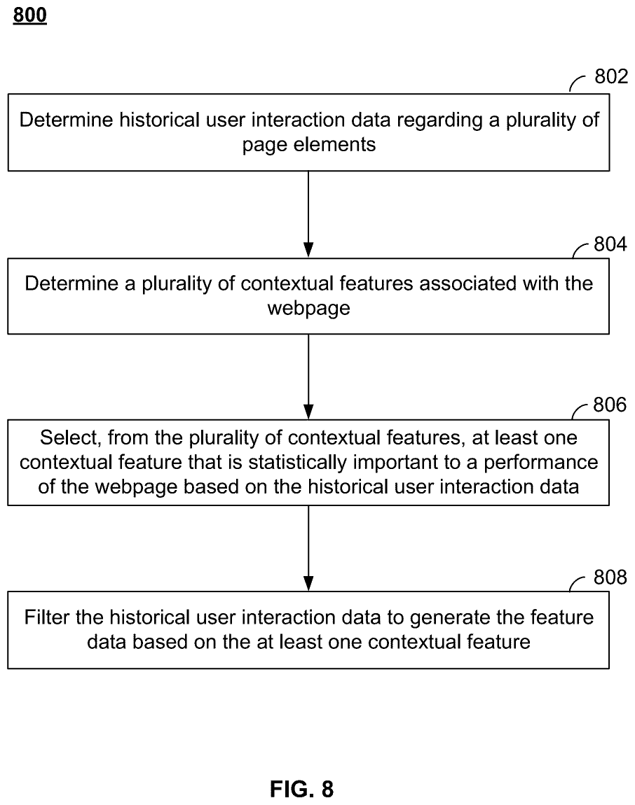

FIG. 8 shows a flowchart illustrating an example method 800 for determining feature data, in accordance with some embodiments. In some embodiments, the method 800 can be carried out by a system including one or more computing devices, such as the webpage layout optimization device 102 and/or the cloud-based engine 121 of FIG. 1. In some embodiments, the method 800 can be performed as part of the operation 704 of the example method 700 in FIG. 7. Beginning at operation 802, historical user interaction data is determined regarding the plurality of page elements. At operation 804, a plurality of contextual features associated with the webpage is determined. At operation 806, from the plurality of contextual features, at least one contextual feature is selected to be statistically important to a performance of the webpage based on the historical user interaction data. At operation 808, the historical user interaction data is filtered to generate the feature data based on the at least one contextual feature.

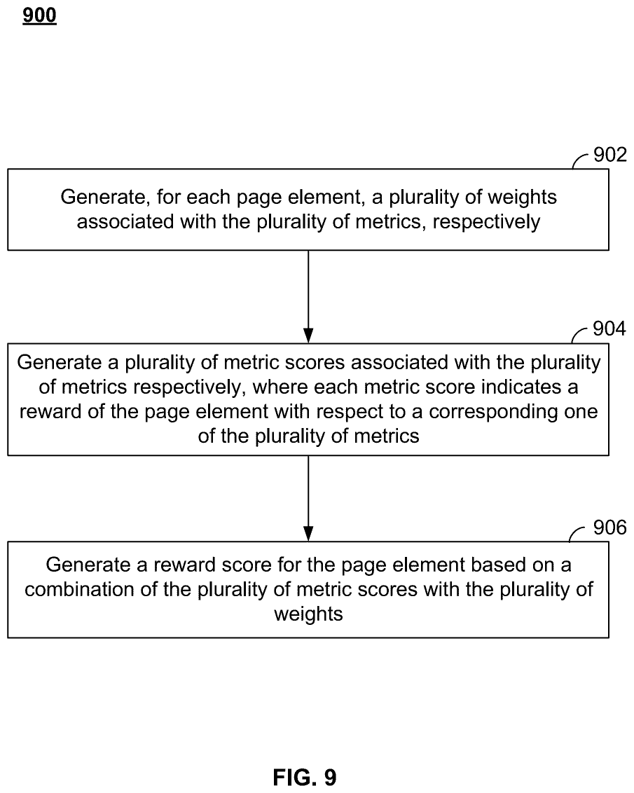

FIG. 9 shows a flowchart illustrating an example method 900 for generating a plurality of reward scores, in accordance with some embodiments. In some embodiments, the method 900 can be carried out by a system including one or more computing devices, such as the webpage layout optimization device 102 and/or the cloud-based engine 121 of FIG. 1. In some embodiments, the method 900 can be performed as part of the operation 708 of the example method 700 in FIG. 7. Beginning at operation 902, for each page element, a plurality of weights are generated to be associated with the plurality of metrics, respectively. At operation 904, a plurality of metric scores are generated to be associated with the plurality of metrics respectively. Each metric score may indicate a reward of the page element with respect to a corresponding one of the plurality of metrics. At operation 906, a reward score is generated for the page element based on a combination of the plurality of metric scores with the plurality of weights.

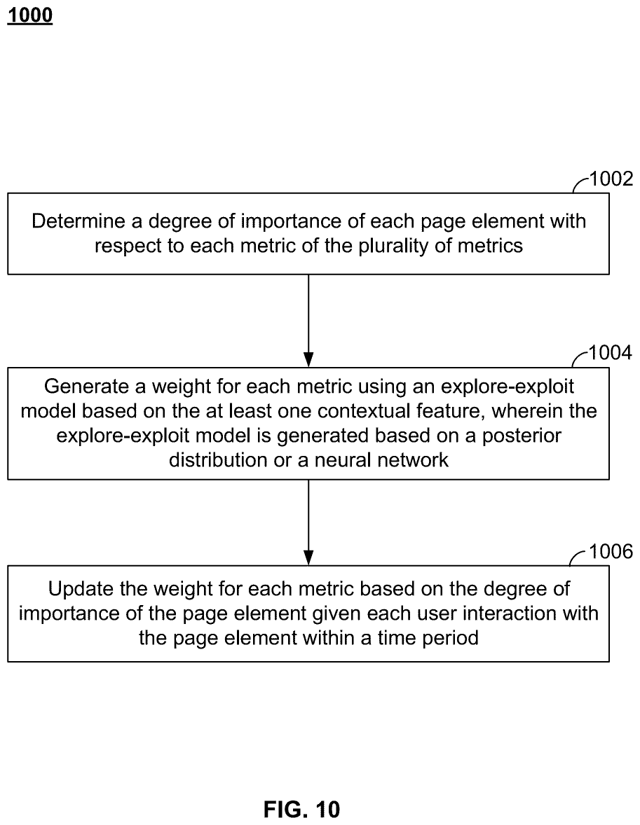

FIG. 10 shows a flowchart illustrating an example method 1000 for generating a plurality of weights, in accordance with some embodiments. In some embodiments, the method 1000 can be carried out by a system including one or more computing devices, such as the webpage layout optimization device 102 and/or the cloud-based engine 121 of FIG. 1. In some embodiments, the method 1000 can be performed as part of the operation 902 of the example method 900 in FIG. 9. Beginning at operation 1002, a degree of importance of each page element is determined with respect to each metric of the plurality of metrics. At operation 1004, a weight is generated for each metric using an explore-exploit model based on the at least one contextual feature. The explore-exploit model may be generated based on a posterior distribution or a neural network. At operation 1006, the weight can be updated for each metric based on the degree of importance of the page element given each user interaction with the page element within a time period.

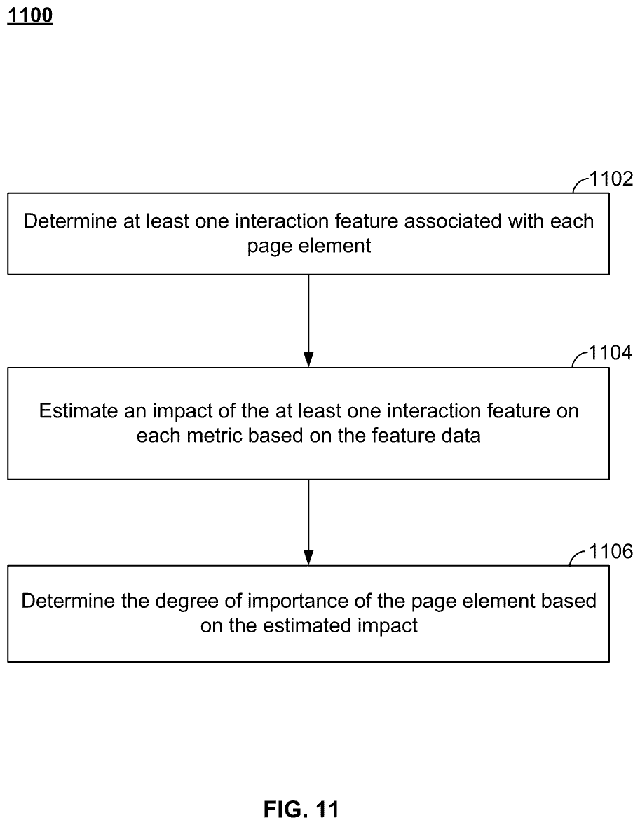

FIG. 11 shows a flowchart illustrating an example method 1100 for determining a degree of importance of a page element, in accordance with some embodiments. In some embodiments, the method 1100 can be carried out by a system including one or more computing devices, such as the webpage layout optimization device 102 and/or the cloud-based engine 121 of FIG. 1. In some embodiments, the method 1100 can be performed as part of the operation 1002 of the example method 1000 in FIG. 10. Beginning at operation 1102, at least one interaction feature is determined to be associated with each page element. At operation 1104, an impact of the at least one interaction feature on each metric is estimated based on the feature data. At operation 1106, the degree of importance of the page element is determined based on the estimated impact.

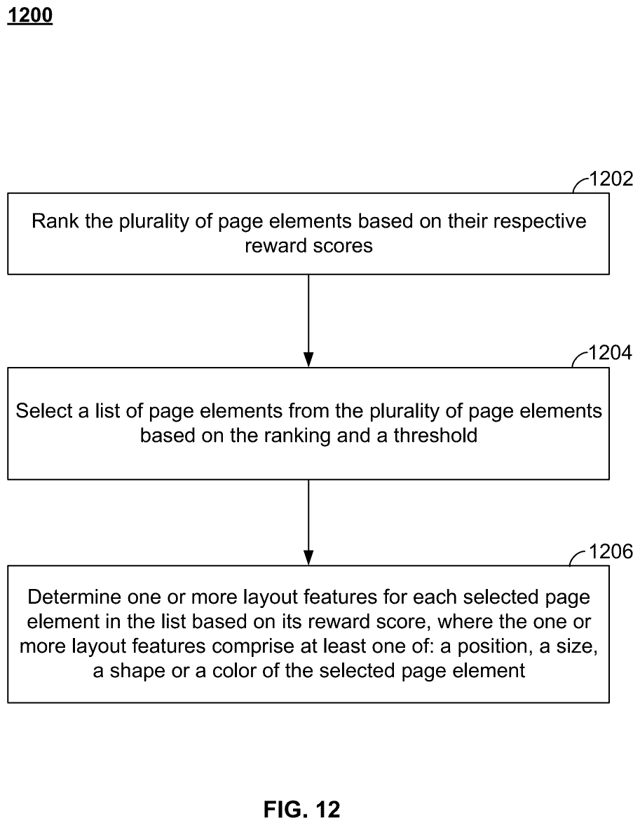

FIG. 12 shows a flowchart illustrating an example method 1200 for determining a layout of a webpage, in accordance with some embodiments. In some embodiments, the method 1200 can be carried out by a system including one or more computing devices, such as the webpage layout optimization device 102 and/or the cloud-based engine 121 of FIG. 1. In some embodiments, the method 1200 can be performed as part of the operation 710 of the example method 700 in FIG. 7. Beginning at operation 1202, the plurality of page elements are ranked based on their respective reward scores. At operation 1204, a list of page elements are selected from the plurality of page elements based on the ranking and a threshold. At operation 1206, one or more layout features are determined for each selected page element in the list based on its reward score. The one or more layout features may comprise at least one of: a position, a size, a shape or a color of the selected page element.

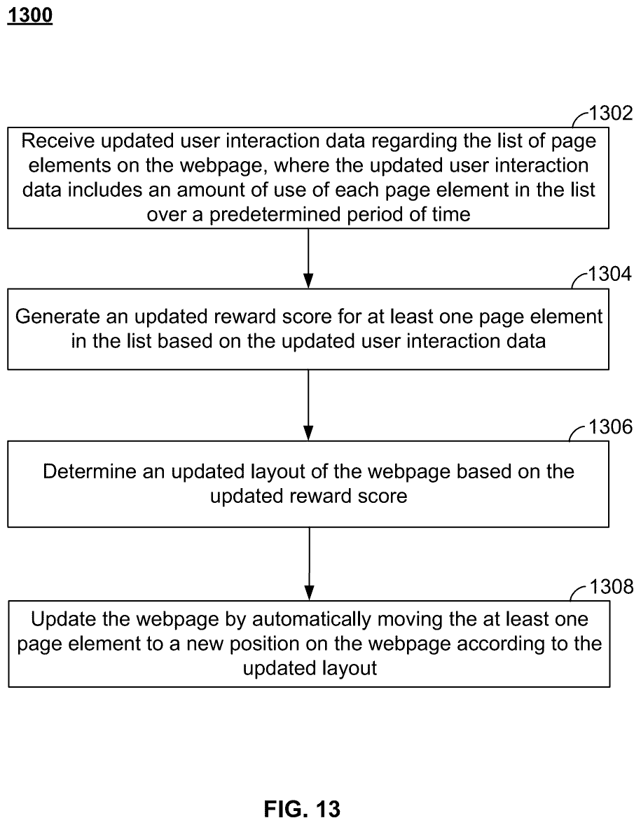

FIG. 13 shows a flowchart illustrating an example method 1300 for updating a layout of a webpage, in accordance with some embodiments. In some embodiments, the method 1200 can be carried out by a system including one or more computing devices, such as the webpage layout optimization device 102 and/or the cloud-based engine 121 of FIG. 1. Beginning at operation 1302, updated user interaction data is received regarding the list of page elements on the webpage. The updated user interaction data may include an amount of use of each page element in the list over a predetermined period of time. At operation 1304, an updated reward score is generated for at least one page element in the list based on the updated user interaction data. At operation 1306, an updated layout of the webpage is determined based on the updated reward score. At operation 1308, the webpage is updated by automatically moving the at least one page element to a new position on the webpage according to the updated layout.

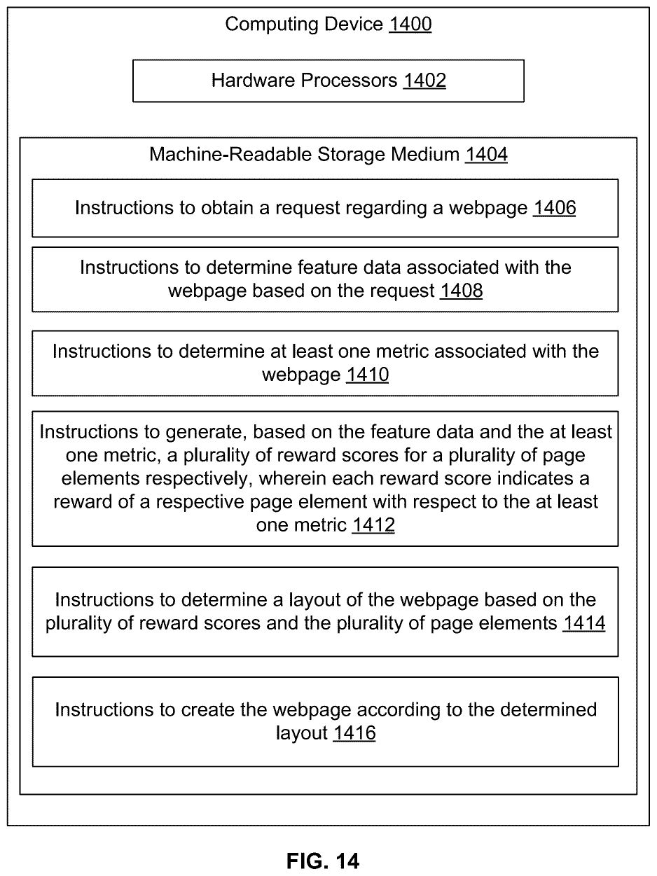

FIG. 14 depicts an example system 1400 (e.g. a computing device) for webpage layout optimization, including a machine-readable medium 1404 encoded with example instructions executable by processing resource 1402, e.g. hardware processors, in accordance with some embodiments. In some implementations, the system 1400 may be useful for implementing aspects of the system 400 of FIG. 4. In some implementations, functionality described with respect to FIG. 4 may be included in the instructions encoded on machine-readable medium 1404.

The processing resource 1402 may include a microcontroller, a microprocessor, central processing unit core(s), an ASIC, an FPGA, and/or other hardware device suitable for retrieval and/or execution of instructions from the machine-readable medium 1404 to perform functions related to various examples. Additionally or alternatively, the processing resource 1402 may include or be coupled to electronic circuitry or dedicated logic for performing some or all of the functionality of the instructions described herein.

The machine-readable medium 1404 may be any medium suitable for storing executable instructions, such as RAM, ROM, EEPROM, flash memory, a hard disk drive, an optical disc, or the like. In some example implementations, the machine-readable medium 1404 may be a tangible, non-transitory medium. The machine-readable medium 1404 may be disposed within the system 1400 in which case the executable instructions may be deemed installed or embedded on the system. Alternatively, the machine-readable medium 1404 may be a portable (e.g., external) storage medium, and may be part of an installation package.

As described further herein below, the machine-readable medium 1404 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 14.

The machine-readable medium 1404 includes instructions 1406-1416. Instructions 1406, when executed, cause the processing resource 1402 to obtain a request regarding a webpage. The instructions 1408, when executed, cause the processing resource 1402 to determine feature data associated with the webpage based on the request. The instructions 1410, when executed, cause the processing resource 1402 to determine at least one metric associated with the webpage.

The instructions 1412, when executed, cause the processing resource 1402 to generate, based on the feature data and the at least one metric, a plurality of reward scores for a plurality of page elements respectively. Each reward score may indicate a reward of a respective page element with respect to the at least one metric. The instructions 1414, when executed, cause the processing resource 1402 to determine a layout of the webpage based on the plurality of reward scores and the plurality of page elements. The instructions 1416, when executed, cause the processing resource 1402 to create (or update) the webpage according to the determined layout.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain a request regarding a webpage,
determine feature data associated with the webpage based on the request,
determine at least one metric associated with the webpage,
generate, based on the feature data and the at least one metric, a plurality of reward scores for a plurality of page elements respectively, wherein each reward score indicates a reward of a respective page element with respect to the at least one metric,
determine a layout of the webpage based on the plurality of reward scores and the plurality of page elements, and
create the webpage according to the determined layout.

2. The system of claim 1, wherein the feature data is determined based on:
determining historical user interaction data regarding the plurality of page elements;
determining a plurality of contextual features associated with the webpage;
selecting, from the plurality of contextual features, at least one contextual feature that is statistically important to a performance of the webpage based on the historical user interaction data; and
filtering the historical user interaction data to generate the feature data based on the at least one contextual feature.

3. The system of claim 2, wherein:
the at least one metric comprises a plurality of metrics; and
the plurality of reward scores are generated based on:
generating, for each page element, a plurality of weights associated with the plurality of metrics, respectively,
generating a plurality of metric scores associated with the plurality of metrics, respectively, wherein each metric score indicates a reward of the page element with respect to a corresponding one of the plurality of metrics, and
generating a reward score for the page element based on a combination of the plurality of metric scores with the plurality of weights.

4. The system of claim 3, wherein generating the plurality of weights for the page element comprises:
determining a degree of importance of the page element with respect to each metric of the plurality of metrics;
generating a weight for each metric using an explore-exploit model based on the at least one contextual feature, wherein the explore-exploit model is generated based on a posterior distribution or a neural network; and
updating the weight for each metric based on the degree of importance of the page element given each user interaction with the page element within a time period.

5. The system of claim 4, wherein determining the degree of importance of the page element with respect to each metric comprises:
determining at least one interaction feature associated with the page element;
estimating an impact of the at least one interaction feature on the metric based on the feature data; and
determining the degree of importance of the page element based on the estimated impact.

6. The system of claim 1, wherein the layout of the webpage is determined based on:
ranking the plurality of page elements based on their respective reward scores;
selecting a list of page elements from the plurality of page elements based on the ranking and a threshold; and
determining one or more layout features for each selected page element in the list based on its reward score, wherein the one or more layout features comprise at least one of: a position, a size, a shape or a color of the selected page element.

7. The system of claim 6, wherein the list of page elements are arranged on the webpage according to the one or more layout features.

8. The system of claim 7, wherein the instructions, when executed, further cause the processor to:
receive updated user interaction data regarding the list of page elements on the webpage, wherein the updated user interaction data includes an amount of use of each page element in the list over a predetermined period of time;
generate an updated reward score for at least one page element in the list based on the updated user interaction data;
determine an updated layout of the webpage based on the updated reward score; and
update the webpage by automatically moving the at least one page element to a new position on the webpage according to the updated layout.

9. A computer-implemented method, comprising:
obtaining a request regarding a webpage;
determining feature data associated with the webpage based on the request;
determining at least one metric associated with the webpage;
generating, based on the feature data and the at least one metric, a plurality of reward scores for a plurality of page elements respectively, wherein each reward score indicates a reward of a respective page element with respect to the at least one metric;
determining a layout of the webpage based on the plurality of reward scores and the plurality of page elements; and
creating the webpage according to the determined layout.

10. The computer-implemented method of claim 9, wherein determining the feature data comprises:
determining historical user interaction data regarding the plurality of page elements;
determining a plurality of contextual features associated with the webpage;
selecting, from the plurality of contextual features, at least one contextual feature that is statistically important to a performance of the webpage based on the historical user interaction data; and
filtering the historical user interaction data to generate the feature data based on the at least one contextual feature.

11. The computer-implemented method of claim 10, wherein:
the at least one metric comprises a plurality of metrics; and
generating the plurality of reward scores comprises:
generating, for each page element, a plurality of weights associated with the plurality of metrics, respectively,
generating a plurality of metric scores associated with the plurality of metrics, respectively, wherein each metric score indicates a reward of the page element with respect to a corresponding one of the plurality of metrics, and
generating a reward score for the page element based on a combination of the plurality of metric scores with the plurality of weights.

12. The computer-implemented method of claim 11, wherein generating the plurality of weights for the page element comprises:
determining a degree of importance of the page element with respect to each metric of the plurality of metrics;
generating a weight for each metric using an explore-exploit model based on the at least one contextual feature, wherein the explore-exploit model is generated based on a posterior distribution or a neural network; and
updating the weight for each metric based on the degree of importance of the page element given each user interaction with the page element within a time period.

13. The computer-implemented method of claim 12, wherein determining the degree of importance of the page element with respect to each metric comprises:
determining at least one interaction feature associated with the page element;
estimating an impact of the at least one interaction feature on the metric based on the feature data; and
determining the degree of importance of the page element based on the estimated impact.

14. The computer-implemented method of claim 9, wherein determining the layout of the webpage comprises:
ranking the plurality of page elements based on their respective reward scores;
selecting a list of page elements from the plurality of page elements based on the ranking and a threshold; and
determining one or more layout features for each selected page element in the list based on its reward score, wherein the one or more layout features comprise at least one of: a position, a size, a shape or a color of the selected page element.

15. The computer-implemented method of claim 14, wherein creating the webpage comprises arranging the list of page elements on the webpage according to the one or more layout features.

16. The computer-implemented method of claim 15, further comprising:
receiving updated user interaction data regarding the list of page elements on the webpage, wherein the updated user interaction data includes an amount of use of each page element in the list over a predetermined period of time;
generating an updated reward score for at least one page element in the list based on the updated user interaction data;
determining an updated layout of the webpage based on the updated reward score; and
updating the webpage by automatically moving the at least one page element to a new position on the webpage according to the updated layout.

17. A non-transitory computer readable medium having instructions stored thereon, wherein the instructions, when executed by at least one processor, cause at least one device to perform operations comprising:
obtaining a request regarding a webpage;
determining feature data associated with the webpage based on the request;
determining at least one metric associated with the webpage;
generating, based on the feature data and the at least one metric, a plurality of reward scores for a plurality of page elements respectively, wherein each reward score indicates a reward of a respective page element with respect to the at least one metric;
determining a layout of the webpage based on the plurality of reward scores and the plurality of page elements; and
creating the webpage according to the determined layout.

18. The non-transitory computer readable medium of claim 17, wherein determining the feature data comprises:
determining historical user interaction data regarding the plurality of page elements;
determining a plurality of contextual features associated with the webpage;
selecting, from the plurality of contextual features, at least one contextual feature that is statistically important to a performance of the webpage based on the historical user interaction data; and
filtering the historical user interaction data to generate the feature data based on the at least one contextual feature.

19. The non-transitory computer readable medium of claim 18, wherein:
the at least one metric comprises a plurality of metrics; and
generating the plurality of reward scores comprises:
generating, for each page element, a plurality of weights associated with the plurality of metrics, respectively,
generating a plurality of metric scores associated with the plurality of metrics, respectively, wherein each metric score indicates a reward of the page element with respect to a corresponding one of the plurality of metrics, and
generating a reward score for the page element based on a combination of the plurality of metric scores with the plurality of weights.

20. The non-transitory computer readable medium of claim 19, wherein generating the plurality of weights for the page element comprises:
determining a degree of importance of the page element with respect to each metric of the plurality of metrics;
generating a weight for each metric using an explore-exploit model based on the at least one contextual feature, wherein the explore-exploit model is generated based on a posterior distribution or a neural network; and
updating the weight for each metric based on the degree of importance of the page element given each user interaction with the page element within a time period.
